(19) United States
(12) Patent Application Publication
(10) Pub. No.: US 2025/0301093 A1
(43) Pub. Date: Sep. 25, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Teppei NAGATOMI, Kanagawa (JP)

(73) Assignee: FUJIFILM Business Innovation Corp., Tokyo (JP)

(21) Appl. No.: 18/769,440

(22) Filed: Jul. 11, 2024

(30) Foreign Application Priority Data
Mar. 21, 2024 (JP) 2024-045321

(51) Int. Cl. H04N 1/60; G06F 3/12

(52) U.S. Cl. CPC H04N 1/6027; G06F 3/1268

(57) ABSTRACT

An information processing system includes a processor configured to, in a case where input information including print information and information related to generation of the print information is input, input new input information including new print information and information related to generation of the new print information to a trained model that has been trained in advance to output application information related to application of color gradation correction with respect to the print information, thereby outputting the application information corresponding to the new input information.

### CROSS-REFERENCE TO RELATED APPLICATIONS

This application is based on and claims priority under 35 USC 119 from Japanese Patent Application No. 2024-045321 filed Mar. 21, 2024.

### BACKGROUND

### (i) Technical Field

The present disclosure relates to an information processing system, a non-transitory computer readable medium storing an information processing program, and an information processing method.

### (ii) Related Art

JP2021-26535A discloses a printing order placing system, which places an order for printing to a factory, the printing order placing system specifying a paper type used in the factory and the amount of used paper based on information collected from the factory at an order placement destination, and transmitting the specified paper type and the amount of paper to a supply source of the used paper.

### SUMMARY

In a case where an object having a gradation expression included in a Page Description Language (PDL) is printed, there is a case where a printing problem called a pseudo contour occurs.

Here, in the gradation expression in which a color is required to smoothly transition, there is a problem in that the color is changed in a portion where a discretized color value changes by 1 unit and the color appears to jump without continuous transition.

In order to respond to this problem, a gradation correction technique that does not allow a human eye to recognize a pseudo contour is used. However, in order to apply a gradation correction process, a processing time is required, the effect is not obtained even in a case where the gradation correction process is applied, and application with respect to all the manuscripts including manuscripts in which the effect cannot be expected is disadvantageous from a viewpoint of the processing time. In addition, there are a plurality of methods in the gradation correction process, and each of the methods has different advantages and disadvantages. Therefore, selective use of the plurality of methods, such as exclusively selecting any one of the methods, using one or more methods together, or not using any method, is required.

A user takes time and effort to perform a work of checking all the characteristics and content of the manuscripts and determining whether or not to use the gradation correction process, and the accuracy of the determination depends on a worker.

Aspects of non-limiting embodiments of the present disclosure relate to an information processing system, a non-transitory computer readable medium storing an information processing program, and an information processing method, which are capable of predicting application of color gradation correction in a case where printing is performed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to, in a case where input information including print information and information related to generation of the print information is input, input new input information including new print information and information related to generation of the new print information to a trained model that has been trained in advance to output application information related to application of color gradation correction with respect to the print information, thereby outputting the application information corresponding to the new input information.

### BRIEF DESCRIPTION OF THE DRAWINGS

Exemplary embodiment(s) of the present invention will be described in detail based on the following figures, wherein

FIG. 1 is a diagram showing a schematic configuration of an information processing system according to the present exemplary embodiment;

FIG. 2 is a block diagram showing a main configuration of electric systems of a printing apparatus in the information processing system according to the present exemplary embodiment;

FIG. 3 is a block diagram showing a main configuration of electric systems of a management apparatus and a client computer in the information processing system according to the present exemplary embodiment;

FIG. 4 is a functional block diagram showing a functional configuration of the client computer in the information processing system according to the present exemplary embodiment;

FIG. 5 is a diagram showing an example of a trained neural network model;

FIG. 6 is a flowchart showing an example of a flow of a training process performed by the client computer of the information processing system according to the present exemplary embodiment; and

FIG. 7 is a flowchart showing an example of a flow of an estimation process performed by the client computer of the information processing system according to the present exemplary embodiment.

### DETAILED DESCRIPTION

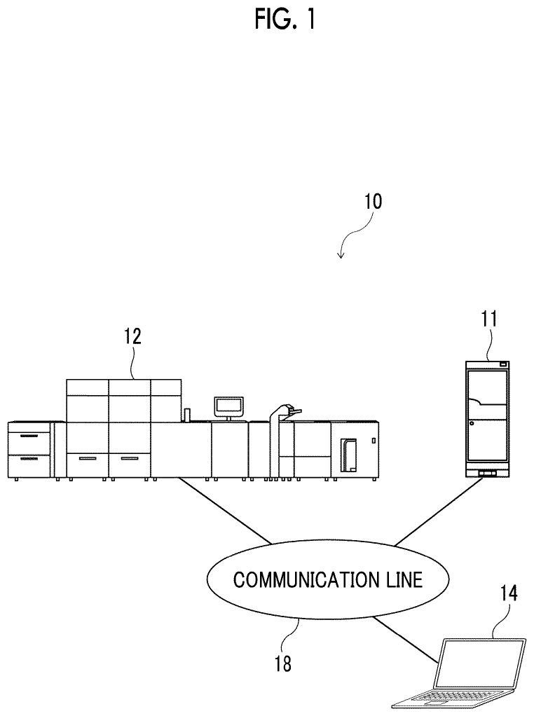

Hereinafter, an example of the present exemplary embodiment will be described in detail with reference to the drawings. In the present exemplary embodiment, an information processing system in which a management apparatus, a printing apparatus, a client computer, and the like are connected to each other via a communication line such as various networks is described as an example. FIG. 1 is a diagram showing a schematic configuration of an information processing system 10 according to the present exemplary embodiment.

As illustrated in FIG. 1, an information processing system 10 according to the present exemplary embodiment includes a management apparatus 11, a printing apparatus 12, a client computer 14, and the like. The management apparatus 11, the printing apparatus 12, and the client computer 14 are connected to each other via a communication line 18 such as a Local Area Network (LAN), a Wide Area Network (WAN), the Internet, and an intranet. Then, each of the management apparatus 11, the printing apparatus 12, and the client computer 14 can transmit and receive various data to and from each other via the communication line 18. In the present exemplary embodiment, printing is performed in the printing apparatus 12 in response to a printing instruction by giving a printing instruction to the printing apparatus 12 from the client computer 14 via the management apparatus 11.

In FIG. 1, one management apparatus 11, one printing apparatus 12, and one client computer 14 are shown, but each of the apparatuses may be plural or any of the apparatuses may be plural.

The printing apparatus 12 according to the present exemplary embodiment has a plurality of functions such as a printing function of performing printing process and a post-treatment function of performing post-treatment on printed paper. The plurality of functions may include a scanning function of scanning a manuscript to obtain image information indicating the manuscript, a duplicating function of duplicating an image recorded in the manuscript on paper, a facsimile function of transmitting and receiving various data via a telephone line (not shown), a transfer function of transferring manuscript information such as the image information scanned by the scanning function, and an accumulating function of accumulating the manuscript information such as the scanned image information.

In the following description, the facsimile function may be referred to as a facsimile, the scanning function may be referred to as a scan, the printing function may be referred to as a print, and the duplicating function may be referred to as a copy.

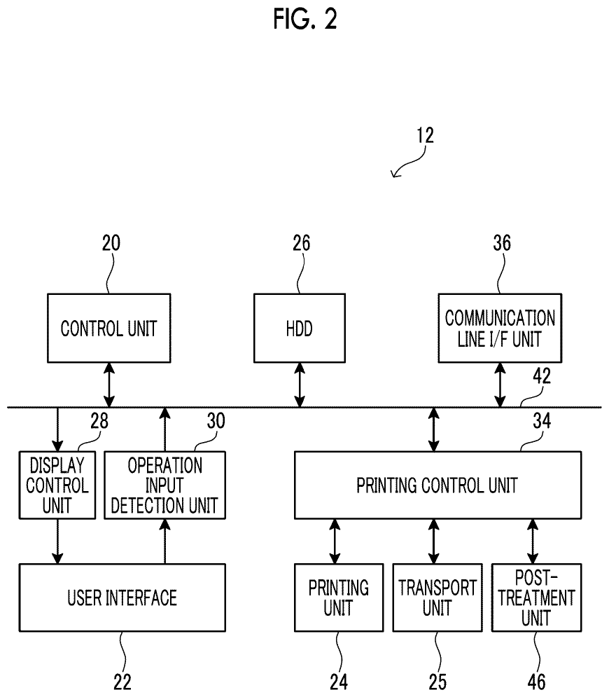

FIG. 2 is a block diagram showing a main configuration of electric systems of the printing apparatus 12 in the information processing system 10 according to the present exemplary embodiment.

As shown in FIG. 2, the printing apparatus 12 according to the present exemplary embodiment includes a control unit 20. The control unit 20 may include a Central Processing Unit (CPU), a Read Only Memory (ROM), and a Random Access Memory (RAM).

On the other hand, the printing apparatus 12 according to the present exemplary embodiment includes a Hard Disk Drive (HDD) 26 that stores various data, application programs, and the like. In addition, the printing apparatus 12 includes a display control unit 28 that is connected to a user interface 22 and controls the display of various operation screens and the like on the display of the user interface 22. Further, the printing apparatus 12 includes an operation input detection unit 30 that is connected to the user interface 22 and detects an operation instruction input via the user interface 22. In the printing apparatus 12, the HDD 26, the display control unit 28, and the operation input detection unit 30 are electrically connected to a system bus 42. In the printing apparatus 12 according to the present exemplary embodiment, the HDD 26 is applied as a storage unit, but the present disclosure is not limited thereto, and a non-volatile storage unit such as a flash memory may be applied. In addition, in the present exemplary embodiment, a touch panel that can perform display and operation input is applied to the user interface 22, but the present disclosure is not limited thereto, and a user interface in which a display and an operation unit are separate may be applied.

In addition, the printing apparatus 12 according to the present exemplary embodiment includes a printing control unit 34 that controls the printing process by the printing unit 24, the transport of the paper to the printing unit 24 by the transport unit 25, and the post-treatment by the post-treatment unit 46. The printing apparatus 12 may include a scanning control unit that controls an optical image reading operation by a manuscript scanning unit and a manuscript feeding operation by a manuscript transport unit. In addition, the printing apparatus 12 includes a communication line interface (I/F) unit 36 that is connected to the communication line 18 and transmits and receives communication data to and from other external apparatuses such as the client computer 14 connected to the communication line 18. Further, the printing apparatus 12 may include a facsimile interface (I/F) unit that is connected to a telephone line (not shown) and transmits and receives facsimile data to and from a facsimile apparatus connected to the telephone line. In addition, the printing apparatus 12 may include a transmission and reception control unit that controls transmission and reception of the facsimile data via the facsimile I/F unit 38. Moreover, in the printing apparatus 12, the printing control unit 34 and the communication line I/F unit 36 are electrically connected to a system bus 42.

With the above configuration, the printing apparatus 12 according to the present exemplary embodiment executes control of display of an operation screen and information, such as various messages, on the display of the user interface 22 via the display control unit 28 by the control unit 20. In addition, the printing apparatus 12 executes, by the control unit 20, each of the control of the operation of the printing unit 24, the transport unit 25, and the post-treatment unit 46 via the printing control unit 34, and the control of the transmission and reception of the communication data via the communication line I/F unit 36. Further, the printing apparatus 12 grasps operation content in the user interface 22 based on operation information, which is detected by the operation input detection unit 30, by the control unit 20 and executes various controls based on the operation content.

As an example of the applications stored in the HDD 26, in the present exemplary embodiment, an application that executes a function such as printing is included.

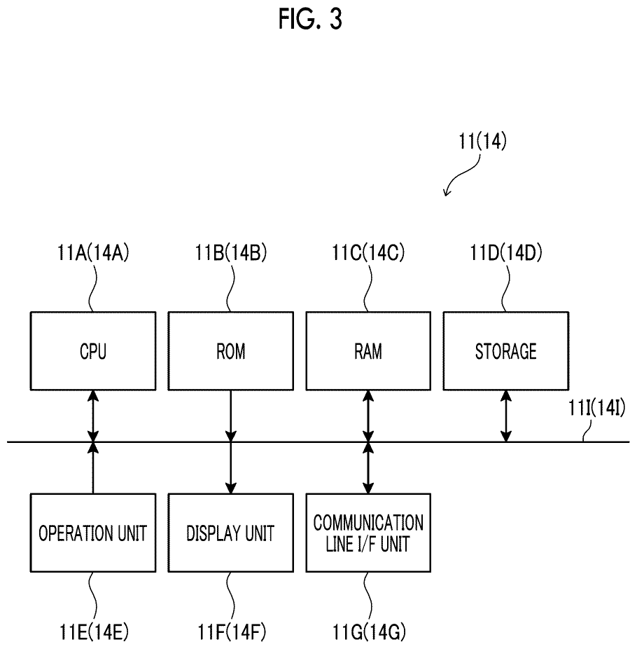

Subsequently, a main configuration of the electric systems of the management apparatus 11 and the client computer 14 according to the present exemplary embodiment will be described. FIG. 3 is a block diagram showing a main configuration of the electric systems of the management apparatus 11 and the client computer 14 in the information processing system 10 according to the present exemplary embodiment. Since the management apparatus 11 and the client computer 14 have a general computer configuration, the management apparatus 11 will be described below as a representative example.

As illustrated in FIG. 3, the management apparatus 11 according to the present exemplary embodiment includes a CPU 11A as an example of a processor, a ROM 11B, a RAM 11C, a storage 11D, an operation unit 11E, a display unit 11F, and a communication line interface (I/F) unit 11G. The CPU 11A controls the whole operation of the management apparatus 11. The ROM 11B stores various control programs, various parameters, and the like in advance. The RAM 11C is used as a work area or the like in a case where various programs are executed by the CPU 11A. The storage 11D stores various data, application programs, and the like. The operation unit 11E is used to input various types of information. The display unit 11F is used for display of the various types of information. The communication line I/F unit 11G is connected to the communication line 18 and transmits and receives various data to and from other apparatuses connected to the communication line 18. In addition, the communication line I/F unit 11G may have a configuration capable of directly communicating with each device by using various well-known wireless communications. Each of the units of the management apparatus 11 described above is electrically connected to each other by a system bus 11I. In the management apparatus 11 according to the present exemplary embodiment, the storage 11D is applied as a storage unit, but as an example of the storage, a non-volatile storage unit, such as a Hard Disk Drive (HDD) or a flash memory, is applied.

With such a configuration, in the management apparatus 11 according to the present exemplary embodiment, the CPU 11A executes accesses to the ROM 11B, the RAM 11C, and the storage 11D, acquisition of various types of data via the operation unit 11E, and display of various types of information on the display unit 11F. In addition, the management apparatus 11 executes control of transmission and reception of the communication data via the communication line I/F unit 11G by the CPU 11A.

In the information processing system 10 having the above-described configuration, the management apparatus 11 manages a series of manufacturing procedures. The series of manufacturing procedures includes, for example, a manufacturing procedure, a pre-press procedure, a plate-making procedure, a printing procedure, a processing procedure, and a distribution procedure.

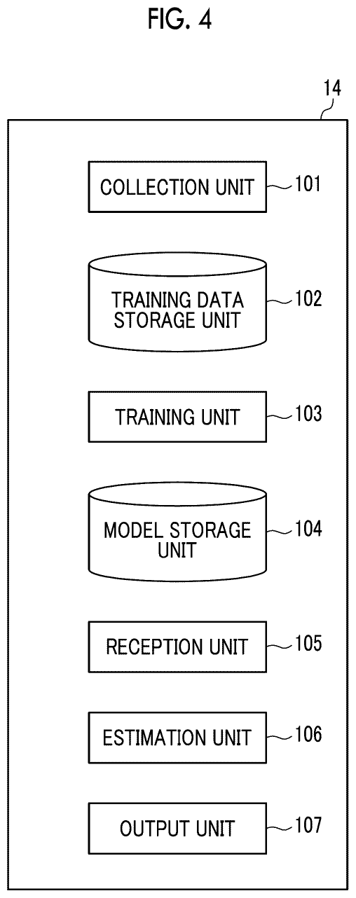

Next, a functional configuration of the client computer 14 will be described. FIG. 4 is a block diagram showing an example of the functional configuration of the client computer 14.

Functionally, as shown in FIG. 4, the client computer 14 is configured to include a collection unit 101, a training data storage unit 102, a training unit 103, a model storage unit 104, a reception unit 105, an estimation unit 106, and an output unit 107.

The collection unit 101 collects training data including a pair of input information related to a print job based on past print information and application information related to application of color gradation correction with respect to the print information corresponding to the input information.

The input information may include print information. The print information includes, for example, the PDL or the like printed by the print job.

The management apparatus 11 has history information for managing information related to an order reception for a printed matter and manufacturing information.

The collection unit 101 collects the print information related to a past print job from the history information included in the management apparatus 11.

The input information may include information related to generation of the print information. The information related to generation of the print information may include information related to an application that generates the print information, information related to a library used by an application, information related to a creator who creates the print information, information related to a creation time at which the print information is created, information related to a printing apparatus that performs printing based on the print information, or the like. Specifically, the information related to the application that generates the print information includes an application name (for example, Word (registered trademark), Adobe Illustrator (registered trademark)), and the like. The information related to a library used by an application includes a library name and the like. The information related to a creator who creates the print information includes information for identifying a creator (for example, a name or an ID), and the like. The information related to a creation time at which the print information is created includes a creation date, a creation date and time, and the like. The information related to a printing apparatus that performs printing based on the print information includes information (for example, a name, an ID, or the like) for identifying the printing apparatus designated in a case of generating the print information.

The collection unit 101 collects information related to generation of the print information from the history information included in the management apparatus 11.

The input information may include information related to a print job based on the print information. The information related to a print job may include a name of the print job or information related to printing in the print job. The name of the print job may include a name given by the worker in a case where the print job is registered. The information related to printing in the print job includes information (for example, a name or an ID) for identifying the job template including various set values (for example, a color to be used, imposition, and the like) used in a case where the print job is registered, or a combination of the various set values in the print job.

The collection unit 101 collects information related to a print job based on the print information from the history information included in the management apparatus 11.

The input information may include information related to a worker who registers a print job. Specifically, the information related to a worker includes information (for example, a name or an ID) for identifying the worker.

The collection unit 101 acquires the information related to a worker who registers the print job from the history information included in the management apparatus 11.

The input information may include information related to a method of inputting a print job to the printing apparatus 12. The information related to a method of inputting a print job includes a type of a method of inputting a print job (for example, an input method using a hot folder).

The collection unit 101 acquires the information related to a method of inputting a print job from the history information included in the management apparatus 11.

In addition, the input information may include information related to the printing apparatus 12 designated in a case where the print job is registered. Specifically, the information related to the printing apparatus 12 designated in a case where the print job is registered includes information (for example, a name or an ID) for identifying a logical or physical printing apparatus designated by the worker in a case where the print job is registered.

The collection unit 101 acquires information related to the printing apparatus 12 designated in a case where the print job is registered from the history information included in the management apparatus 11.

The input information may include information related to a result of the confirmation process performed in advance with respect to the print job. Specifically, the information related to a result of the confirmation process performed in advance includes information (a color space, a type of an object such as an image or a text, presence or absence of a feature, and the like) of the object used in the print information obtained by the confirmation process (for example, the preflight process) performed in advance.

The collection unit 101 acquires information related to a result of the confirmation process performed in advance with respect to the print job from the history information included in the management apparatus 11.

The application information related to application of color gradation correction with respect to the past print information is managed by the management apparatus 11 as the history information, and the collection unit 101 acquires the application information related to application of color gradation correction with respect to the print information from the management apparatus 11.

The application information related to application of color gradation correction with respect to the print information includes the applied type of color gradation correction or the application or non-application of color gradation correction. The applied type of color gradation correction may be equal to or more than two types.

Specifically, in a case where the worker sets whether or not to apply color gradation correction with respect to the print information and the type of color gradation correction to be applied by manual input for the assigned print job, the application information related to application of color gradation correction is managed in the management apparatus 11 as the history information. The collection unit 101 acquires application information related to application of color gradation correction, which is set by the manual input by the worker.

The training data storage unit 102 stores a plurality of pieces of training data collected by the collection unit 101.

The training unit 103 constructs a neural network model for estimating application information related to application of color gradation correction corresponding to the input information with the input information as an input based on the plurality of pieces of training data.

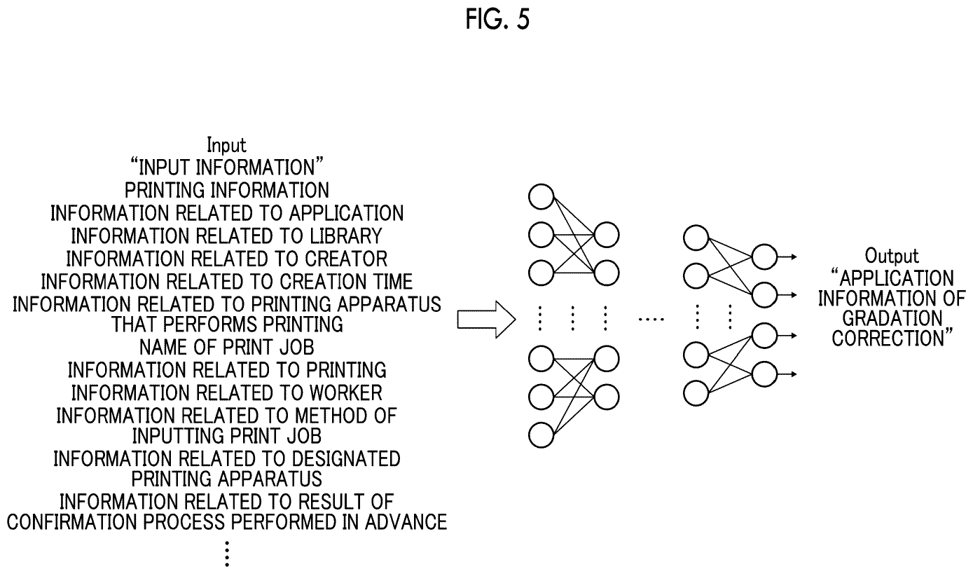

Specifically, the trained neural network model receives input of input information including at least one of the print information, the information related to an application, the information related to a library, the information related to a creator, the information related to a creation time, the information related to the printing apparatus 12 that performs printing, the name of a print job, the information related to printing, the information related to a worker, the information related to a method of inputting the print job, the information related to the designated printing apparatus 12, or the information related to a result of a confirmation process performed in advance, and outputs the application information related to application of color gradation correction corresponding to the input information (see FIG. 5). Deep learning can be used as an example of a training algorithm, and a neural network model may be constructed such that, in a case where input information of the training data is input, the application information related to application of color gradation correction of the training data is output.

More specifically, the input information of the training data is input, the application information related to application of color gradation correction is estimated as the output of the model, and the estimated application information related to application of color gradation correction is compared with the application information related to application of color gradation correction of the training data, so that the parameters of the model may be updated to calculate an error of the application information related to application of color gradation correction and to minimize the value of an error.

Here, a correlation between various types of information included in the input information and application information related to application of color gradation correction will be described.

First, the characteristic of the print information may be shown by a specific application that generates the print information or a library, and there is a case where a scene in which color gradation correction is not applied can be specified, or a case where it can be determined that color gradation correction is better to be applied. Therefore, there is a correlation between the information related to an application, the information related to a library, and the application information related to application of color gradation correction.

In addition, there is a case where the characteristics (form, photobook, direct mail) of the manuscript are specified by the information related to a creator of the print information, and whether or not to apply color gradation correction can be determined according to each characteristic. Therefore, there is a correlation between the information related to a creator and the application information related to application of color gradation correction.

In addition, there is a case where the characteristics of the manuscript (all of the manuscripts are images, only CMYK color space is used, and the like) appear by the printing apparatus 12 designated in a case where the print information is generated, and whether or not to apply color gradation correction can be determined by each characteristic. Therefore, there is a correlation between the information related to the printing apparatus 12 that performs printing and the application information related to application of color gradation correction.

In addition, the worker can know the utilization achievements of the color gradation correction. Therefore, there is a correlation between the information related to the worker and the application information related to application of color gradation correction.

In addition, there is a case where the characteristic of the print job is specified by an input method. For example, there is a case where the color gradation correction is not applied to the print job input by a specific input method. Therefore, there is a correlation between the information related to a method of inputting a print job and the application information related to application of color gradation correction.

In addition, there is a case where the information on the logical printing apparatus 12 and the job template information designated in a case where the print job is registered are used by being switched for each orderer of the printed matter, and the both information can be used as information for determining whether or not to apply color gradation correction. Therefore, there is a correlation between the information related to the printing, the information related to the designated printing apparatus 12, and the application information related to application of color gradation correction.

In addition, there is a case where the worker manages the information of the orderer or the setting of the job using the job name, so that the information can be used as information for determining whether or not to apply color gradation correction. Therefore, there is a correlation between the name of the print job and the application information related to application of color gradation correction.

In addition, it can be seen that, in the information of the object used in the print information obtained by the confirmation process performed in advance, in a case where the gradation object is not present, the color gradation correction is not applied. Therefore, there is a correlation between the information related to the result of the confirmation process in advance and the application information related to application of color gradation correction.

The model storage unit 104 stores a trained neural network model.

The reception unit 105 receives input information related to new print information to be estimated.

The input information includes the new print information.

The input information includes information related to generation of the print information. The information related to generation of the print information may include information related to an application that generates the print information, information related to a library used by an application, information related to a creator who creates the print information, information related to a creation time at which the print information is created, information related to a printing apparatus that performs printing based on the print information, or the like. For example, the application name “Word (registered trademark)” that generates the print information, the name of a library used by the application, information for identifying a creator who creates the print information, a creation date and time at which the print information is created, and information for identifying a printing apparatus designated in a case where the print information is generated, which are acquired from the management apparatus 11, are received.

In addition, the input information may include the information related to the print job based on the print information. The information related to a print job may include a name of the print job or information related to printing in the print job.

For example, the information for identifying the name of the print job and the job template used in a case where the print job is registered, which are acquired from the management apparatus 11, is received.

The input information may include information related to a worker who registers a print job. For example, the information for identifying the worker who registers the print job, which is acquired from the management apparatus 11, is received.

In addition, the input information may include information related to a method of inputting a print job to the printing apparatus 12. For example, the type of a method of inputting a print job, which is acquired from the management apparatus 11 is received.

In addition, the input information may include information related to the printing apparatus 12 designated in a case where the print job is registered. For example, the information for identifying the logical printing apparatus designated by the worker in a case where the print job is registered, which is acquired from the management apparatus 11, is received.

The input information may include information related to a result of the confirmation process performed in advance with respect to the print job. For example, the information “CMYK, image, no feature” of the object used in the print information, which is acquired from the management apparatus 11 and is obtained in the confirmation process performed in advance, is received.

The estimation unit 106 estimates the application information related to application of color gradation correction corresponding to the received input information, using the trained neural network model stored in the model storage unit 104.

Specifically, various types of information included in the received input information are converted into data structures (for example, a scalar value, a vector, and the like) that can be input to the trained neural network model, the information is input to the trained neural network model, and the application information related to application of color gradation correction is estimated from an output of the trained model.

The output unit 107 sets the estimated application information related to application of color gradation correction to the print job. Specifically, for each piece of the print information of the print job, the estimated application information related to application of color gradation correction is set with respect to the print information.

Next, specific processing performed by each part of the information processing system 10 according to the present exemplary embodiment configured as described above will be described.

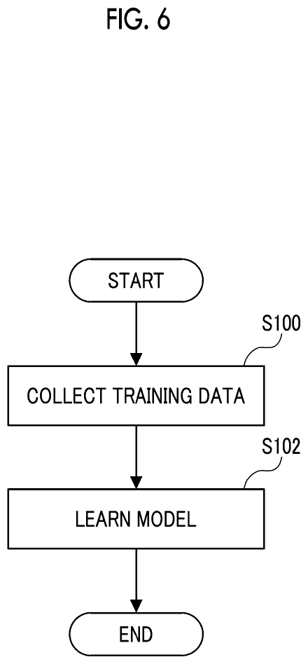

First, in the client computer 14, the CPU 14A reads out the training program from the ROM 14B or the storage 14D, and develops and executes the training program on the RAM 14C to perform a training process shown in FIG. 6.

In step S100, as the collection unit 101, the CPU 14A collects the training data including a pair of the input information related to the print job based on the past print information and the application information related to application of color gradation correction corresponding to the input information, and stores the training data in the training data storage unit 102.

In step S102, as the training unit 103, the CPU 14A learns the neural network model for estimating the application information related to application of color gradation correction corresponding to the input information with the input information as an input based on the plurality of pieces of training data, stores the trained neural network model in the model storage unit 104, and ends the training process.

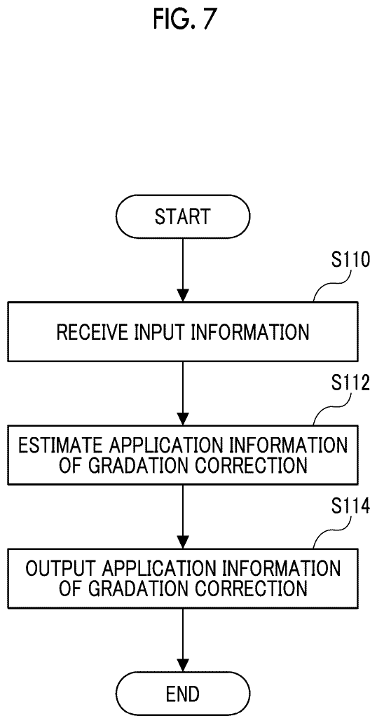

Next, in the client computer 14, the CPU 14A reads out the estimation program from the ROM 14B or the storage 14D and develops and executes the estimation program in the RAM 14C, so that the estimation process shown in FIG. 7 is performed. In this case, it is assumed that various types of information included in the input information related to the new print information to be estimated are input. In a case where the plurality of pieces of the print information are included in the print job, the estimation process is repeatedly performed for each piece of the print information.

In step S110, as the reception unit 105, the CPU 14A receives the input information related to the new print information to be estimated, which is input by the user.

In step S112, as the estimation unit 106, the CPU 14A estimates the application information related to application of color gradation correction corresponding to the received input information for each object included in the print information, using the trained neural network model stored in the model storage unit 104.

In step S114, as the output unit 107, the CPU 14A sets the estimated application information related to application of color gradation correction for each object with respect to the print information, and ends the estimation process. Then, the print job based on the print information is processed by the printing apparatus 12.

By performing the process in this way, the application of the color gradation correction may be predicted in a case where printing is performed.

### Modification Example

The present invention is not limited to the above-described exemplary embodiment, and various modifications and applications are possible without departing from the gist of the present invention.

In the exemplary embodiment described above, a case has been described as an example where the estimation unit 106 inputs the input information to the trained neural network model for an object included in the print information as a target, for each object, to output the application information corresponding to the input information, but the present disclosure is not limited thereto. For example, the estimation unit 106 may input the input information to the trained neural network model for each print job to output the application information corresponding to the input information. In this case, the application information related to application of color gradation correction may be set for each object included in the print job.

In addition, the estimation unit 106 may input the input information to the trained neural network model for each print page included in the print job to output the application information corresponding to the input information. In this case, the application information related to application of color gradation correction may be set for each object included in the print page.

In addition, while a case where the various types of information of the input information are received and the application information related to application of color gradation correction is estimated has been described as an example, the application information related to application of color gradation correction may be estimated by receiving a part of the various types of information of the input information without receiving all of the various types of information of the input information.

In addition, while a case where the client computer 14 trains the model and estimates the application information related to application of color gradation correction has been described as an example, the model may be configured to include a training apparatus for training the model and an estimation apparatus for estimating the application information related to application of color gradation correction.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the “system” in the present exemplary embodiment is described as an example of a system configured to include a plurality of apparatus, but may be configured to include a single apparatus having a part of functions of the plurality of apparatus.

The processes executed by the printing apparatus 12 according to the above exemplary embodiment may be processes executed by software, processes executed by hardware, or a combination of both. In addition, the processes executed by the printing apparatus 12 may be stored in a storage medium as a program and distributed.

In addition, the present disclosure is not limited to the above description, and various modifications other than the above description may be made without departing from the gist thereof.

Regarding the above exemplary embodiments, the following supplementary notes will be further disclosed.

(((1)))

An information processing system comprising:
a processor configured to:
   in a case where input information including print information and information related to generation of the print information is input, input new input information including new print information and information related to generation of the new print information to a trained model that has been trained in advance to output application information related to application of color gradation correction with respect to the print information, to output the application information corresponding to the new input information.
      (((2)))

The information processing system according to (((1))),
wherein the information related to generation of the print information includes information related to an application that generates the print information, information related to a library used by the application, information related to a creator who creates the print information, information related to a creation time at which the print information is created, or information related to a printing apparatus that performs printing based on the print information.
   (((3)))

The information processing system according to (((1))) or ((2))),
wherein the input information and the new input information further include information related to a print job based on the print information.
   (((4)))

The information processing system according to (((3))),
wherein the information related to the print job includes a name of the print job or information related to printing in the print job.
   (((5)))

The information processing system according to any one of (((1))) to (((4))),
wherein the input information and the new input information further include information related to a worker who registers a print job based on the print information.
   (((6)))

The information processing system according to any one of (((1))) to (((5))),
wherein the input information and the new input information further include information related to a method of inputting a print job based on the print information to a printing apparatus.
   (((7)))

The information processing system according to any one of (((1))) to (((6))),
wherein the input information and the new input information further include information related to a printing apparatus designated in a case where a print job is registered based on the print information.
   (((8)))

The information processing system according to any one of (((1))) to (((7))),
wherein the input information and the new input information further include information related to a result of a confirmation process performed in advance with respect to a print job based on the print information.
   (((9)))

The information processing system according to any one of (((1))) to (((8))), wherein the processor is configured to:
input new input information to the trained model for a print job based on the print information, a print page, or an object included in the print information as a target, to output the application information corresponding to the new input information.
   (((10)))

The information processing system according to any one of (((1))) to ((9))), wherein the processor is configured to:
set the output application information for a print job based on the print information.
   (((11)))

A non-transitory computer readable medium storing an information processing program causing a computer to perform a process comprising:
in a case where input information including print information and information related to generation of the print information is input, inputting new input information including new print information and information related to generation of the new print information to a trained model that has been trained in advance to output application information related to application of color gradation correction with respect to the print information, to output the application information corresponding to the new input information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
in a case where input information including print information and information related to generation of the print information is input, input new input information including new print information and information related to generation of the new print information to a trained model that has been trained in advance to output application information related to application of color gradation correction with respect to the print information, thereby outputting the application information corresponding to the new input information.

2. The information processing system according to claim 1,
wherein the information related to generation of the print information includes information related to an application that generates the print information, information related to a library used by the application, information related to a creator who creates the print information, information related to a creation time at which the print information is created, or information related to a printing apparatus that performs printing based on the print information.

3. The information processing system according to claim 1,
wherein the input information and the new input information further include information related to a print job based on the print information.

4. The information processing system according to claim 3,
wherein the information related to the print job includes a name of the print job or information related to printing in the print job.

5. The information processing system according to claim 1,
wherein the input information and the new input information further include information related to a worker who registers a print job based on the print information.

6. The information processing system according to claim 1,
wherein the input information and the new input information further include information related to a method of inputting a print job based on the print information to a

7. The information processing system according to claim 1,
wherein the input information and the new input information further include information related to a printing apparatus designated in a case where a print job is registered based on the print information.

8. The information processing system according to claim 1,
wherein the input information and the new input information further include information related to a result of a confirmation process performed in advance with respect to a print job based on the print information.

9. The information processing system according to claim 1, wherein the processor is configured to:
input new input information to the trained model for a print job based on the print information, a print page, or an object included in the print information as a target, to output the application information corresponding to the new input information.

10. The information processing system according to claim 1, wherein the processor is configured to:
set the output application information for a print job based on the print information.

11. A non-transitory computer readable medium storing an information processing program causing a computer to perform a process comprising:
in a case where input information including print information and information related to generation of the print information is input, inputting new input information including new print information and information related to generation of the new print information to a trained model that has been trained in advance to output application information related to application of color gradation correction with respect to the print information, thereby outputting the application information corresponding to the new input information.

12. An information processing method comprising:
in a case where input information including print information and information related to generation of the print information is input, inputting new input information including new print information and information related to generation of the new print information to a trained model that has been trained in advance to output application information related to application of color gradation correction with respect to the print information, thereby outputting the application information corresponding to the new input information.
